(19) United States
(12) Patent Application Publication
(10) Pub. No.: US 2009/0182893 A1
(43) Pub. Date: Jul. 16, 2009

(54) CACHE COHERENCE IN A VIRTUAL MACHINE MANAGED SYSTEM

(76) Inventors: Vaijayanthimala K. Anand, Austin, TX (US); Bret Ronald Olszewski, Austin, TX (US); Mysore Sathyanarayana Srinivas, Austin, TX (US)

Correspondence Address: IBM CORP (YA);C/O YEE & ASSOCIATES PC, P.O. BOX 802333, DALLAS, TX, 75380, US

(21) Appl. No.: 11/972,788

(22) Filed: Jan. 11, 2008

(51) Int. Cl. G06F 15/173

(52) U.S. Cl. 709/238

(57) ABSTRACT

A method, a system, and computer readable program code for managing cache coherence in a virtual machine managed system are provided. In response to a processor issuing a message to be broadcast, a determination is made as to whether the processor is part of a virtual domain. In response to a determination that the processor is part of the virtual domain, the message and a first bit mask are sent from a source node to a destination node. In response to receiving the message and the first bit mask, one of a primary link or a secondary link is selected to send the message and the first bit mask over, forming a selected link. The message and the first bit mask are sent to the destination node over the selected link.

### BACKGROUND OF THE INVENTION

1. Field of the Invention

The present invention relates generally to multiprocessor data processing systems. More specifically, exemplary embodiments provide a method, computer program product, and a system for managing cache coherence in a logically partitioned data processing system.

2. Description of the Related Art

Increasingly large symmetric multiprocessor data processing systems are not being used as single large data processing systems. Instead, these types of data processing systems are being partitioned and used as smaller virtual systems managed by a virtual machine. These systems are also referred to as logical partitioned (LPAR) data processing systems. A logical partitioned functionality within a data processing system allows multiple copies of a single operating system or multiple heterogeneous operating systems to be simultaneously run on a single data processing system platform. A partition, within which an operating system image runs, is assigned a non-overlapping subset of the platform resources. These platform allocable resources include one or more architecturally distinct processors and their interrupt management area, regions of system memory, and input/output (I/O) adapter bus slots. The partition's resources are represented by the platform's firmware to the operating system image or by another level of software virtual machine to the operating system image.

Each distinct operating system or image of an operating system running within a platform is protected from each other, such that software errors on one logical partition cannot affect the correct operation of any of the other partitions. This protection is provided by allocating a disjointed set of platform resources to be directly managed by each operating system image and by providing mechanisms for ensuring that the various images cannot control any resources that have not been allocated to that image. Furthermore, software errors in the control of an operating system's allocated resources are prevented from affecting the resources of any other image. Thus, each image of the operating system or each different operating system directly controls a distinct set of allocable resources within the platform.

With respect to hardware resources in a logical partitioned data processing system, these resources are shared dis-jointly among various partitions. These resources may include, for example, input/output (I/O) adapters, memory DIMMs, non-volatile random access memory (NVRAM), and hard disk drives. I/O adapters can also be virtualized where multiple partitions share I/O; however, the virtual I/O server will provide security and isolation between partitions. The same is true for memory DIMMs also, through virtual real memory, a virtual machine virtualizes memory DIMMs similar to how operating system virtualizes memory through paging. Disk drives and NVRAM may be the only two hardware resources that are not virtualized today. Each partition within a logical partitioned data processing system may be booted and shut down repeatedly without having to power-cycle the entire data processing system.

When a system is partitioned, as is done using virtualization technology, processors are shared between partitions in fractional units, or processors are dedicated in whole units to individual partitions. Virtualization is a broad term that refers to the abstraction of computer resources. Virtualization is a technique for hiding the physical characteristics of computing resources from the way in which other systems, applications, or end users interact with those resources. This includes making a single physical resource, such as a server, an operating system, an application, or a storage device, appear to function as multiple logical resources; or it can include making multiple physical resources, such as storage devices or servers, appear as a single logical resource.

A mix of these dedicated partitions and shared partitions can co-exist in the same system. These small pools of processors associated with a partition or multiple partitions mostly share the resources allocated within the pool creating multiple isolated systems within a single multiprocessor system. This thwarts the notion of a multiprocessor system's resource sharing concept.

Cache coherence protocol plays an important role in maintaining a coherent memory system of a multiprocessor system. In information technology, a protocol is a special set of rules that end points in a telecommunication connection use when they communicate. Protocols exist at several levels in a telecommunication connection. For example, there are protocols for the data interchange at the hardware device level and protocols for data interchange at the application program level. In the standard model known as Open Systems Interconnection (OSI), there are one or more protocols at each layer in the telecommunication exchange that both ends of the exchange must recognize and observe.

Cache coherence protocol is a protocol for managing the caches of a multiprocessor system so that no data is lost or overwritten before the data is transferred from a cache to the target memory. When two or more computer processors work together on a single program, known as multiprocessing, each processor may have its own memory cache that is separate from the larger RAM that the individual processors will access. A memory cache, sometimes called a cache store or RAM cache, is a portion of memory made of high-speed static RAM (SRAM) instead of the slower and cheaper dynamic RAM (DRAM) used for main memory. Memory caching is effective because most programs access the same data or instructions repeatedly. By keeping as much of this information as possible in SRAM, the computer avoids accessing the slower DRAM.

When multiple processors with separate caches share a common memory, it is necessary to keep the caches in a state of coherence by ensuring that any shared operand that is changed in any cache is changed throughout the entire system. This is done in either of two ways: through a directory-based or a snooping system. In a directory-based system, the data being shared is placed in a common directory that maintains the coherence between caches. The directory acts as a filter through which the processor must ask permission to load an entry from the primary memory to its cache. When an entry is changed, the directory either updates or invalidates the other caches with that entry. In a snooping system, all caches on the bus monitor, or snoop, the bus to determine if they have a copy of the block of data that is requested on the bus. Every cache has a copy of the sharing status of every block of physical memory the cache has.

Cache misses and memory traffic due to shared data blocks limit the performance of parallel computing in multiprocessor computers or systems. Cache coherence aims to solve the problems associated with sharing data. In a multiprocessor system, the memory is viewed as a single entity shared by all processors in the system. Cache coherence protocol creates a significant amount of traffic in the system buses and interconnects to keep the memory coherent. However, with virtualization technology, systems are not used as a single unit. Rather, the systems are partitioned into multiple units. Still, the cache coherence protocol in the system treats the whole system as a single unit, which results in unnecessary traffic in the buses and interconnects.

### SUMMARY OF THE INVENTION

Exemplary embodiments provide for a method, a system and computer program code for managing cache coherence in a virtual machine managed system. In response to a processor issuing a message to be broadcast, a determination is made as to whether the processor is part of a virtual domain. In response to a determination that the processor is part of the virtual domain, the message and a first bit mask are sent from a source node to a destination node. The source node is a node to which the processor belongs and the destination node is another node in the virtual domain. The first bit mask indicates whether an interconnect is a primary link, a secondary link, or neither a primary nor a secondary link. A primary link is an interconnect that directly connects a node in a virtual domain to another node in the virtual domain. A secondary link is an interconnect that connects a node in the virtual domain to another node in the virtual domain through one or more nodes that are not part of the virtual domain. In response to receiving the message and the first bit mask, one of a primary link or a secondary link is selected to send the message and the first bit mask over, forming a selected link. The message and the first bit mask are sent to the destination node over the selected link.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which illustrative embodiments may be implemented;

FIG. 2 is a block diagram of an exemplary logical partitioned platform in which illustrative embodiments may be implemented;

FIG. 3 is a block diagram illustrating a system for managing cache coherence in a virtual machine managed system in accordance with an exemplary embodiment;

FIG. 4 depicts a block diagram of a bit mask for determining membership in a virtual domain in accordance with an exemplary embodiment;

FIG. 5 is a block diagram of a bit mask that maps the interconnects of a set of nodes in accordance with an exemplary embodiment;

FIG. 6 is a flowchart illustrating the operation of managing cache coherence in a virtual machine managed system in accordance with an exemplary embodiment; and

FIGS. 7A & 7B are a flowchart illustrating the operation creating a routing bit mask in accordance with an exemplary embodiment.

### DETAILED DESCRIPTION OF THE PREFERRED EMBODIMENT

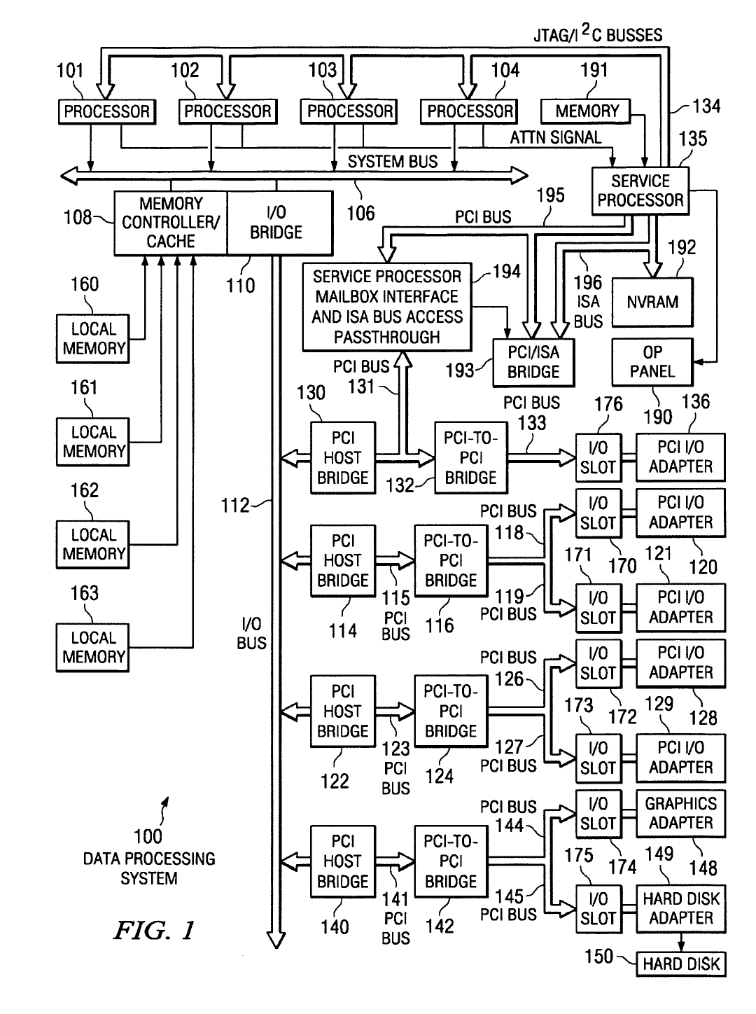

With reference now to the figures, and in particular with reference to FIG. 1, a block diagram of a data processing system in which illustrative embodiments may be implemented is depicted. Data processing system 100 may be a symmetric multiprocessor (SMP) system including processors 101, 102, 103, and 104, which connect to system bus 106. For example, data processing system 100 may be an IBM eServer, a product of International Business Machines Corporation in Armonk, N.Y., implemented as a server within a network. Alternatively, a single processor system may be employed. Also connected to system bus 106 is memory controller/cache 108, which provides an interface to local memories 160, 161, 162, and 163. I/O bridge 110 connects to system bus 106 and provides an interface to I/O bus 112. Memory controller/cache 108 and I/O bridge 110 may be integrated as depicted.

Data processing system 100 is a logical partitioned (LPAR) data processing system. Thus, data processing system 100 may have multiple heterogeneous operating systems (or multiple instances of a single operating system) running simultaneously. Each of these multiple operating systems may have any number of software programs executing within it. Data processing system 100 is logically partitioned such that different PCI I/O adapters 120, 121, 128, 129, and 136, graphics adapter 148, and hard disk adapter 149 may be assigned to different logical partitions. In this case, graphics adapter 148 connects to a display device (not shown), while hard disk adapter 149 connects to and controls hard disk 150.

Thus, for example, suppose data processing system 100 is divided into three logical partitions, P1, P2, and P3. Each of PCI I/O adapters 120, 121, 128, 129, and 136, graphics adapter 148, hard disk adapter 149, each of host processors 101, 102, 103, and 104, and memory from local memories 160, 161, 162, and 163 is assigned to each of the three partitions. In these examples, memories 160, 161, 162, and 163 may take the form of dual in-line memory modules (DIMMs). DIMMs are not normally assigned on a per DIMM basis to partitions. Instead, a partition will get a portion of the overall memory seen by the platform. For example, processor 101, some portion of memory from local memories 160, 161, 162, and 163, and I/O adapters 120, 12a, and 129 may be assigned to logical partition P1; processors 102 and 103, some portion of memory from local memories 160, 161, 162, and 163, and PCI I/O adapters 121 and 136 may be assigned to partition P2; and processor 104, some portion of memory from local memories 160, 161, 162, and 163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX) operating system may be executing within partition P1, a second instance (image) of the AIX operating system may be executing within partition P2, and a Linux or OS/400 operating system may be operating within logical partition P3.

Peripheral component interconnect (PCI) host bridge 114 connected to I/O bus 112 provides an interface to PCI local bus 115. PCI I/O adapters 120 and 121 connect to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 connects to a plurality of PCI I/O adapters 128 and 129. PCI I/O adapters 128 and 129 connect to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. Consequently, data processing system 100 allows connections to multiple network computers.

A memory mapped graphics adapter 148 is inserted into I/O slot 174 and connects to I/O bus 112 through PCI bus 144, PCI-to-PCI bridge 142, PCI bus 141, and PCI host bridge 140. Hard disk adapter 149 may be placed into I/O slot 175, which connects to PCI bus 145. In turn, this bus connects to PCI-to-PCI bridge 142, which connects to PCI host bridge 140 by PCI bus 141.

A PCI host bridge 130 provides an interface for PCI bus 131 to connect to I/O bus 112. PCI I/O adapter 136 connects to I/O slot 176, which connects to PCI-to-PCI bridge 132 by PCI bus 133. PCI-to-PCI bridge 132 connects to PCI bus 131. This PCI bus also connects PCI host bridge 130 to the service processor mailbox interface and ISA bus access pass-through 194 and PCI-to-PCI bridge 132. Service processor mailbox interface and ISA bus access pass-through 194 forwards PCI accesses destined to the PCI/ISA bridge 193. NVRAM storage 192 connects to the ISA bus 196. Service processor 135 connects to service processor mailbox interface and ISA bus access pass-through logic 194 through its local PCI bus 195. Service processor 135 also connects to processors 101, 102, 103, and 104 via a plurality of JTAG/I²C busses 134. JTAG/I²C busses 134 are a combination of JTAG/scan busses (see IEEE 1149.1) and Phillips I²C busses. However, alternatively, JTAG/I²C busses 134 may be replaced by only Phillips I²C busses or only JTAG/scan busses. All SP-ATTN signals of the host processors 101, 102, 103, and 104 connect together to an interrupt input signal of service processor 135. Service processor 135 has its own local memory 191 and has access to the hardware OP-panel 190.

When data processing system 100 is initially powered up, service processor 135 uses the JTAG/I²C busses 134 to interrogate the system (host) processors 101, 102, 103, and 104, memory controller/cache 108, and I/O bridge 110. At the completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101, 102, 103, and 104, memory controller/cache 108, and I/O bridge 110. Any error information for failures detected during the BISTs, BATs, and memory tests are gathered and reported by service processor 135.

If a meaningful and valid configuration of system resources is still possible after taking out the elements found to be faulty during the BISTs, BATs, and memory tests, then data processing system 100 is allowed to proceed to load executable code into local (host) memories 160, 161, 162, and 163. Service processor 135 then releases host processors 101, 102, 103, and 104 for execution of the code loaded into local memory 160, 161, 162, and 163. While host processors 101, 102, 103, and 104 are executing code from respective operating systems within data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101, 102, 103, and 104, local memories 160, 161, 162, and 163, and I/O bridge 110.

Service processor 135 saves and reports error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for de-configuration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM eServer iSeries Model 840 system available from International Business Machines Corporation. Such a system may support logical partitioning using an OS/400 operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to illustrative embodiments.

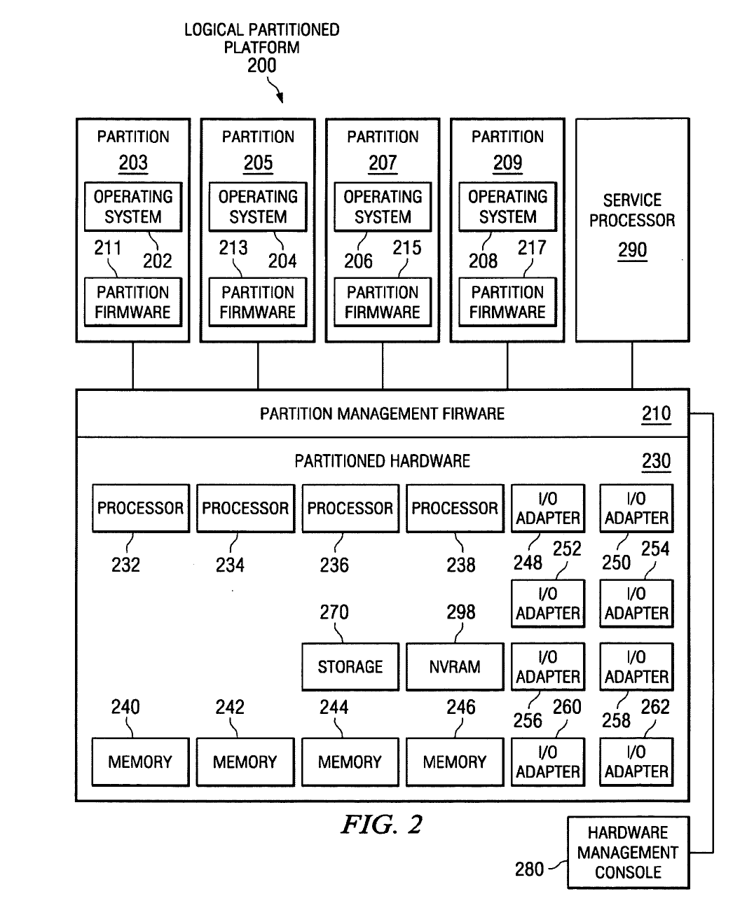

With reference now to FIG. 2, a block diagram of an exemplary logical partitioned platform is depicted in which illustrative embodiments may be implemented. The hardware in logical partitioned platform 200 may be implemented as, for example, data processing system 100 in FIG. 1. Logical partitioned platform 200 includes partitioned hardware 230, operating systems 202, 204, 206, 208, and partition management firmware 210. Operating systems 202, 204, 206, and 208 may be multiple copies of a single operating system or multiple heterogeneous operating systems simultaneously run on logical partitioned platform 200. These operating systems may be implemented using OS/400, which are designed to interface with a partition management firmware, such as Hypervisor, which is available from International Business Machines Corporation. OS/400 is used only as an example in these illustrative embodiments. Of course, other types of operating systems, such as AIX and Linux, may be used depending on the particular implementation. Operating systems 202, 204, 206, and 208 are located in partitions 203, 205, 207, and 209. Hypervisor software is an example of software that may be used to implement partition management firmware 210 and is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, these partitions also include partition firmware 211, 213, 215, and 217. Partition firmware 211, 213, 215, and 217 may be implemented using initial boot strap code, IEEE-1275 Standard Open Firmware, and runtime abstraction software (RTAS), which is available from International Business Machines Corporation. When partitions 203, 205, 207, and 209 are instantiated, a copy of bootstrap code is loaded onto partitions 203, 205, 207, and 209 by platform firmware 210. Thereafter, control is transferred to the bootstrap code with the bootstrap code then loading the open firmware and RTAS. The processors associated or assigned to the partitions are then dispatched to the partition's memory to execute the partition firmware.

Partitioned hardware 230 includes processors 232, 234, 236, and 238, memories 240, 242, 244, and 246, input/output (I/O) adapters 248, 250, 252, 254, 256, 258, 260, and 262, and a storage unit 270. Each of processors 232, 234, 236, and 238, memories 240, 242, 244, and 246, NVRAM storage 298, and I/O adapters 248, 250, 252, 254, 256, 258, 260, and 262 may be assigned to one of multiple partitions within logical partitioned platform 200, each of which corresponds to one of operating systems 202, 204, 206, and 208.

Partition management firmware 210 performs a number of functions and services for partitions 203, 205, 207, and 209 to create and enforce the partitioning of logical partitioned platform 200. Partition management firmware 210 is a firmware implemented virtual machine identical to the underlying hardware. Thus, partition management firmware 210 allows the simultaneous execution of independent OS images 202, 204, 206, and 208 by virtualizing all the hardware resources of logical partitioned platform 200.

Service processor 290 may be used to provide various services, such as processing of platform errors in the partitions. These services also may act as a service agent to report errors back to a vendor, such as International Business Machines Corporation. Operations of the different partitions may be controlled through a hardware management console, such as hardware management console 280. Hardware management console 280 is a separate data processing system from which a system administrator may perform various functions including reallocation of resources to different partitions.

As larger multiprocessor systems are built, virtualization is used in scaling these large systems. While the system is partitioned to scale, the underlying hardware mechanisms, the engines, and protocols still treat the system as a whole system, which impedes the success of virtualization technology.

Cache coherence protocols at hardware layer treat the multiprocessor, Non-Uniform Memory Access (NUMA) systems as a single system and maintain a coherent memory system through coherence schemes like snoopy, directory, and interconnect network schemes. A NUMA multiprocessing architecture is an architecture in which memory is separated into close and distant banks. NUMA is similar to SMP, in which multiple processors share a single memory. However, in SMP, all processors access a common memory at the same speed. In NUMA, memory on the same processor board as the processor, known as local memory, is accessed faster than memory on other processor boards, which is known as shared memory, hence the “non-uniform” nomenclature. As a result, NUMA architecture scales much better to higher numbers of processors than does SMP architecture. “Cache coherent NUMA” means that caching is supported in the local system.

Snoopy is a kind of snooping cache protocol. Sometimes referred to as a bus-snooping protocol, a snooping protocol is a protocol for maintaining cache coherency in symmetric multiprocessing environments. In a snooping system, all caches on the bus monitor, or snoop, the bus to determine if the caches have a copy of the block of data that is requested on the bus. Every cache has a copy of the sharing status of every block of physical memory the cache has. Multiple copies of a document in a multiprocessing environment typically can be read without any coherence problems; however, a processor must have exclusive access to the bus in order to write.

There are two types of snooping protocol, write-invalidate and write-update. In a write-invalidate snooping protocol, the processor that is writing data causes copies in the caches of all other processors in the system to be rendered invalid before the processor changes the processor's local copy. The local data processing system does this by sending an invalidation signal over the bus, which causes all of the other caches to check for a copy of the invalidated file. Once the cache copies have been invalidated, the data on the local data processing system can be updated until another processor requests the data.

In a write-update snooping protocol, the processor that is writing the data broadcasts the new data over the bus (without issuing the invalidation signal). All caches that contain copies of the data are then updated. This scheme differs from write-invalidate in that it does not create only one local copy for writes.

Multiple optimization techniques have been implemented to reduce the traffic that is generated from cache coherence in the system such as node domain systems. A node domain system is a system that has multiple domains or subsystems. Each subsystem is also called a node and all the nodes are interconnected to derive a larger system. However, all these schemes have to broadcast cache coherence related messages across the whole system, called a system pump, and all the nodes, at some level or just within a node, called a nodal pump, which is within the physical boundaries of a node.

The architecture depicting how these processors and nodes are abstracted by the virtualization technology is not filtered down to hardware engines to optimize the system performance. Exemplary embodiments provide for mapping the architecture of the virtual processors abstraction, by overlaying this abstracted architecture on top of the node domain systems or SMP systems and enabling the cache coherence engine to use the virtualized abstracted architecture to optimize cache coherence traffic. This abstracted mapping achieves greater performance as the abstracted mapping creates isolation between non-shared processors or resources matching to how the system is used rather than matching to how the system is built. This virtualization abstraction architecture is dynamic. As this abstraction architecture changes, the underlying cache coherence engine dynamically changes the boundaries of virtual domains for managing cache coherence. A communication mechanism is enabled between cache coherence engine and the virtual machine to transfer the dynamic changes of the virtualization abstraction architecture. These virtualization abstraction architecture changes can be made by changing the logical partition configurations.

The processors and their associated memory caches that are allocated to a virtualized environment, such as a shared pool, generally, are not used in partitions outside this shared pool and may be treated as isolated systems. However, there are some instances of common code such as the virtual machine code and direct memory access (DMA) from I/O space that may share the memory in the whole system.

DMA is a feature of modern data processing systems that allows certain hardware subsystems within the data processing system to access system memory for reading and/or writing independently of the processor. Many hardware systems use DMA including disk drive controllers, graphics cards, network cards, and sound cards. Data processing systems that have DMA channels can transfer data to and from devices with much less overhead than computers without a DMA channel. Therefore, in this special case, these regions of shared memory need to be treated as “global to the system.” Currently, solutions exist to implement this special case. The present disclosure does not address this issue.

Exemplary embodiments provide for isolating the processors that are part of the isolated systems, along with their associated memory controllers, cache coherence snoops, directory, and network schemes. This reduces the message traffic in the bus from the snoops.

Exemplary embodiments provide for assigning all the processors that belong to a single shared pool to a single virtual node domain. A cache coherence engine primarily virtualizes cache coherence among multiple virtual domains using cache directory scheme per virtual domain. Cache lines associated with processors belonging to a virtual domain are treated as one system for cache coherence purposes. The cache coherence protocol specifies one single message to communicate to all the processors within a virtual domain. However, this virtual domain might contain more than one physical node or domain. All the physical nodes within the virtual domain are considered as the “virtual home” domain for the shared pool. This means that the cache coherence is maintained only among the processors in the virtual home node, which might cross physical nodes. This is because multiple physical domains or nodes can be part of one virtual domain. For example, if each physical domain contains 8 processors and the shared pool configuration requires 16 processors than 2 physical domains will be part of one virtual domain.

Similarly, in the case of dedicated partitions, a virtual home node can be created using only the processor or processors and their memory controllers that are assigned to a dedicated partition.

Also in both dedicated and shared partitions, processors/memory can be moved from one virtual node domain to another virtual node domain dynamically. As these changes to virtual node domains occur, the underlying cache coherence protocol engine is also made to adapt to these changes by communicating the new mappings to the cache coherence engine, which in turn reconfigures its virtual domain boundaries. The cache coherence engine treats each virtual domain as a separate system for cache coherence.

Exemplary embodiments provide for one additional bit in the cache directory, wherein the additional bit indicates whether a system level pump, a local node pump, or no pump is needed per cache line. This additional bit is used to indicate that the cache line is not only part of the virtual domain but also shared by all processors in the system. Memory regions that are used for by DMA and virtual machine require a system pump. The cache coherence engine will make that distinction and will do a system pump for cache lines that are marked as belonging to the system encompassing all the physical domains. In a multi-node or domain system, information can be localized when resources are not shared across nodal boundaries. In such cases, node pumping is preferred to system pumping. Node pumping indicates that the snoop and address assertion are all completed within the node. The traffic from the node is not seen in the interconnected links between nodes. System level pumping sends a broadcast, either a snoop or address assertion, to all nodes. Therefore, all the interconnect links will see the broadcast traffic.

A dedicated processor partition comprises a subset of logical resources that are capable of supporting an operating system. A logical partition consists of CPUs, memory, and I/O slots that are a subset of the pool of available resources within a system. A dedicated processor partition has an entire processor assigned to a partition. These processors are owned by the partition where they are running and are not shared with other partitions. Also, the amount of processing capacity on the partition is limited by the total processing capacity of the number of processors configured in that partition, and it cannot go over this capacity. However, physical processors can be divided into virtual processors that are assigned to partitions. A shared processor partition, or shared pool, therefore consists of one or more virtual processors, and can support an operating system.

In shared processor partitions, processors within a shared pool stay within the shared pool. Therefore, there is no need to pump address or data message broadcasts to all the other processors in the entire system. The memory shared by the processors in the pool can also be isolated. The virtual domain is constructed using only the resources in the shared pool. Therefore, the cache coherence and memory store serialization have to be maintained only among the resources in the shared pool.

Since the virtual domain, even though the underlying hardware is all inter-connected, is, for all intents and purposes of the system, an isolated entity. In a NUMA system, the memories, network caches, and the interconnection network are kept in coherence with the home memory of a block being the main serialization point. In a virtual domain, the inter-connection network is used to create this isolation. The address request and data packets carry destination address with routing bit mask.

At the interconnection, a decision is made as to the route the packet takes into that node. If the routing bit mask indicates that the resource on the other side of the interconnect is part of the virtual domain, then the packets are routed through that interconnect. This assumes that the resources in the shared pool are contiguously connected. In cases where the resources in a shared pool are not contiguously connected, the routing bit mask indicates that the intermediate or secondary node is a link to a resource that is part of the shared pool. The secondary node may have multiple links, and one or more links may connect to the resource (node) that is part of the virtual domain. A distinction is made between interconnects that are primary or secondary links to a virtual domain and those that do not connect at all to the virtual domain using the routing bit mask. Thus, packets are sent only onto the links that are connected to virtual domain resources. Therefore, exemplary embodiments utilize existing cache coherence schemes (either snoop or directory) and modify the existing cache coherence schemes by using the routing bit mask and multicasting the packets to a set of nodes that are either part of the virtual domain or are intermediate nodes that connect to a virtual domain resource. A multicast is mechanism by which a packet is delivered to a set of selected nodes. Multicasting is a process whereby a source host or protocol entity sends a packet to multiple destinations simultaneously using a single, local transmit operation.

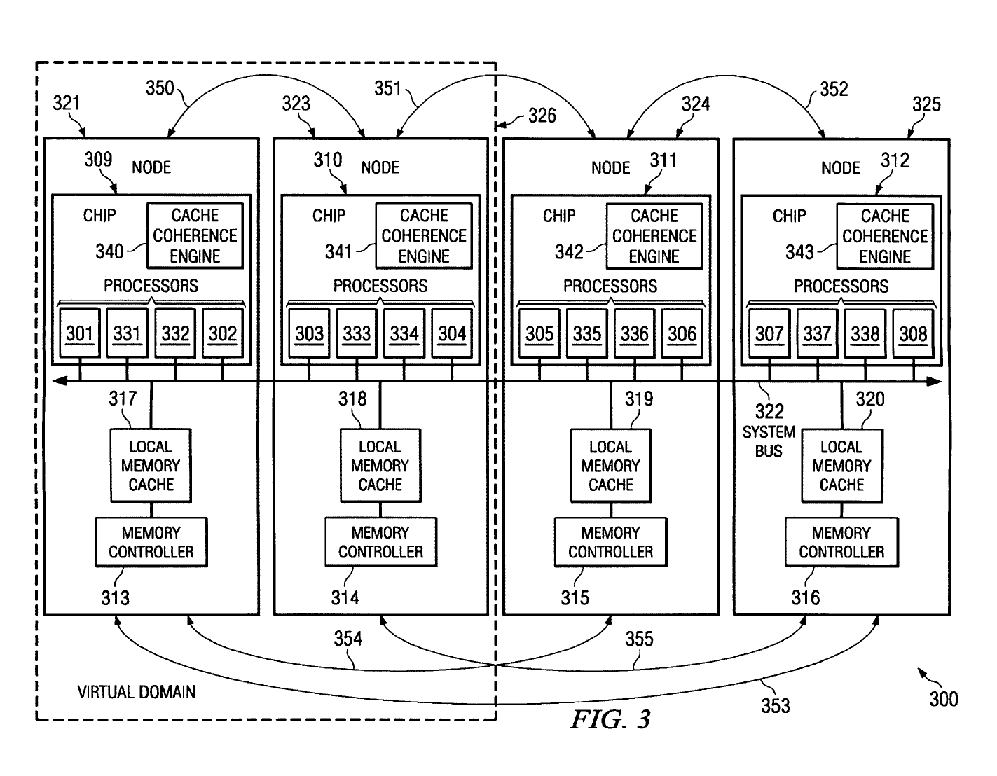

Turning back to the figures, FIG. 3 is a block diagram illustrating a system for managing cache coherence in a virtual machine managed system in accordance with an exemplary embodiment.

Multiprocessor system 300 comprises sixteen (16) processors, processors 301-308 and 331-338, on four (4) chips, chips 309-312, each chip having four (4) processors and a cache coherence engine, cache coherence engines 340-343. Each chip has a memory controller, such as memory controllers 313-316, and local memory caches, such as local memory caches 317-320, that are dedicated to the chip. Memory controllers 313-316 and local memory caches 317-320 are connected to chips 309-312 via bus 322. Specifically, memory controller 313 and local memory cache 317 belong to chip 309. Memory controller 314 and local memory cache 318 belong to chip 310. Memory controller 315 and local memory cache 319 belong to chip 311. Memory controller 316 and local memory cache 320 belong to chip 312.

Each chip and its associated memory controller and local memory cache is assigned to a node. Chip 309 is assigned to node 321. Chip 310 is assigned to node 323. Chip 311 is assigned to node 324. Chip 312 is assigned to node 325.

Virtual domain 326 is a logical partition comprising two nodes, nodes 321 and 323. Physical nodes 321, 323, 324, 325 are connected via a series of interconnects, interconnects 350-355. Interconnects 350-355 are two-way communication paths. That is, communication can flow in both directions through the interconnect. Nodes 321 and 323 are connected via interconnect 350. Nodes 321 and 324 are connected via interconnect 354. Nodes 321 and 325 are connected via interconnect 353. Nodes 323 and 324 are connected via interconnect 351. Nodes 323 and 325 are connected via interconnect 355. Nodes 324 and 325 are connected via interconnect 352.

As memory controllers 313 and 314 and local memory caches 317 and 318 belong only to nodes 321 and 323, and thus processors 301-304, the processors do not need to communicate with the other processors, processors 305-308 in multiprocessor system 300, regarding what processors 301-304 are doing with memory controllers 313 and 314 and local memory caches 317 and 318.

Virtual domain 326 accesses memory that no one in the system is using but virtual domain 326. Therefore, no one will be changing the memory contents of either memory controllers 313 and 314 and local memory caches 317 and 318 while processors 301-304 access a cache line from memory. Thus, virtual domain 326 modifies this cache line, but virtual domain 326 does not have to tell any other processors, nodes, or partitions about the modifications. Virtual domain 326 can write back the changed cache line to the memory.

Normally, according to the cache coherency protocol, when any of processors 301-304 accesses a cache line of data from memory, the processor sends out a snoop message to every other processor in the system to see if the cache line that the processor desires to access, is being used by other processors. The message is sent via bus 322.

According to the exemplary embodiment shown in FIG. 3, this snoop message is a waste of the bandwidth of bus 322 because no one else is using the desired cache line because the cache line of memory is assigned only to virtual domain 326. Thus, cache coherency needs to be maintained only between the eight (8) processors that are part of virtual domain 326.

Thus, exemplary embodiments utilize cache coherence engines, such as cache coherence engines 340-343, to influence the flow of packets through the interconnects between the nodes. Thus, when a processor, such as processor 301 issues a read/write request, an address request is sent to the local bus of the node to determine if the data is already located in the local caches or in its local memory. If it does not exist in the local caches and memory, then the cache coherence engine 340 determines what interconnects to use to broadcast the address request only to nodes that are part of the virtual domain, excluding the nodes that are not part of the virtual domain. In this sense, the cache coherence engine also limits other address and data requests to flow within the virtual domain.

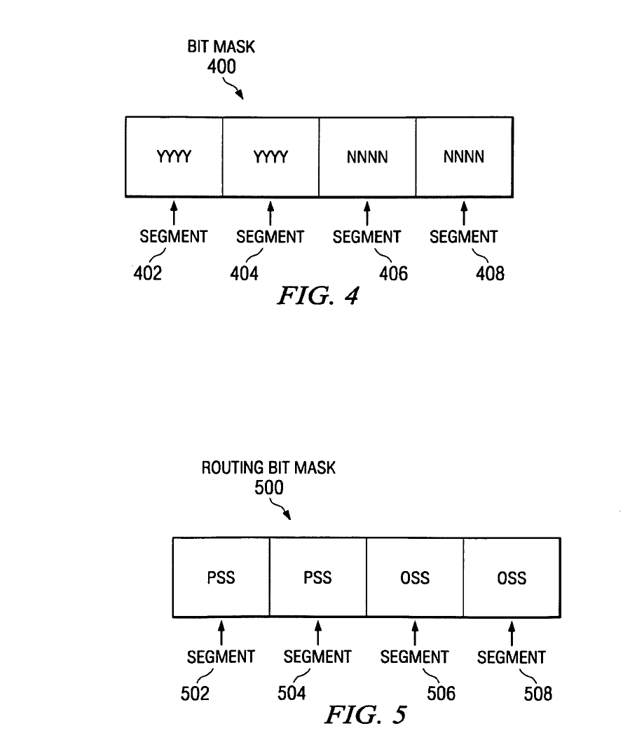

FIG. 4 depicts a block diagram of a bit mask for determining membership in a virtual domain in accordance with an exemplary embodiment. Bit mask 400 comprises four segments, segments 402, 404, 406, and 408, each of which represents a node in multiprocessor system 300 of FIG. 3. Segment 402 represents node 321. Segment 404 represents node 323. Segment 406 represents node 324. Segment 408 represents node 325.

As each node represented by bit mask 400 has four processors in the node, each segment of bit mask 400 has four bits, each bit representing one processor in the node. The four bits in segment 402 represents the four processors, processors 301, 302, 331, and 332 of node 321 of FIG. 3. The four bits in segment 404 represents the four processors, processors 303, 304, 333, and 334 of node 323 of FIG. 3. The four bits in segment 406 represents the four processors, processors 305, 306, 335, and 336 of node 324 of FIG. 3. The four bits in segment 408 represents the four processors, processors 307, 308, 337, and 338 of node 325 of FIG. 3.

A “Y” bit means that processor belongs to virtual domain 326, while an “N” bit means that the processor is not part of virtual domain 326 of FIG. 3. Thus, in bit mask 400, one can see that all four processors of segments 402 and 404, which represents the processors of nodes 321 and 323 belong to virtual domain 326, while none of the processors in segments 406 and 408 belong to virtual domain 326.

In an alternate exemplary embodiment, a “Y” indicates that a dynamic random access memory (DRAM) memory module in the node is part of the virtual domain. In the alternate exemplary embodiment, an “N” indicates that a dynamic random access memory (DRAM) memory module in the node is not part of the virtual domain. In another alternate exemplary embodiment, a “Y” indicates that either a processor or a dynamic random access memory (DRAM) memory module associated with the processor is part of the virtual domain. In the other alternate exemplary embodiment, an “N” indicates that both the processor and the dynamic random access memory (DRAM) memory module associated with the processor are not part of the virtual domain. In an additional alternate embodiment, a “Y” indicates that both the processor and the dynamic random access memory (DRAM) memory module associated with the processor are part of the virtual domain. In the additional alternate exemplary embodiment, an “N” indicates that either a processor or a dynamic random access memory (DRAM) memory module associated with the processor is not part of the virtual domain.

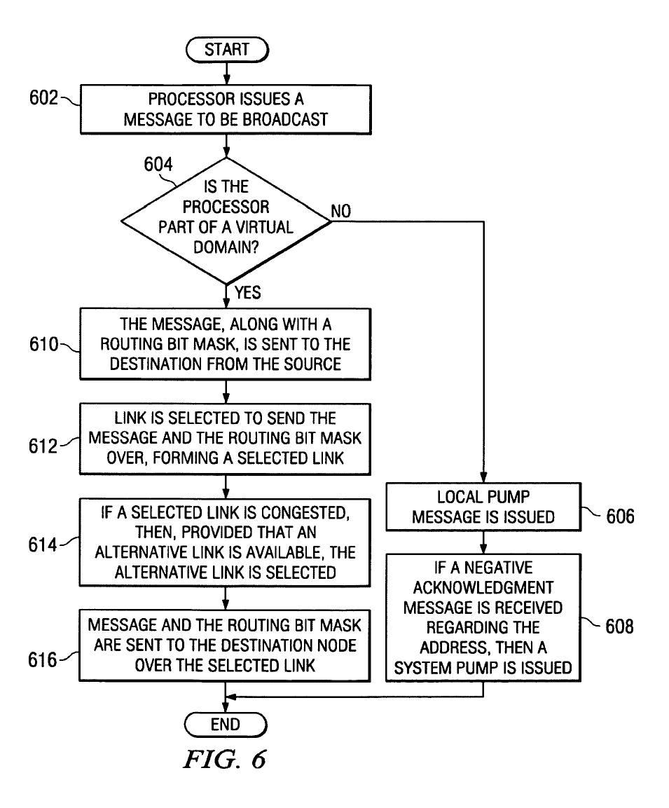

FIG. 5 is a block diagram of a bit mask that maps the interconnects of a set of nodes in accordance with an exemplary embodiment. A routing bit mask is specific to a particular virtual domain. That is, a routing bit mask indicates whether an interconnect is connected to node of one particular virtual domain. Thus, if a system comprises multiple virtual domains, a separate routing bit mask would exist for each virtual domain, indicating whether or not interconnects are connected to nodes belonging to that specific virtual domain.

Routing bit mask 500 maps the interconnects of multiprocessor system 300 in FIG. 3. Routing bit mask 500 comprises four segments, segments 502, 504, 506, and 508, each of which represents a node in multiprocessor system 300 of FIG. 3. As each node in multiprocessor system 300 has three interconnects, each segment in routing bit mask 500 comprises 3 bits, and each bit representing a single interconnect of the node.

Segment 502 represents node 321 with interconnects 350, 353, and 354 of FIG. 3. Segment 504 represents node 323 with interconnects 350, 351, and 355 of FIG. 3. Segment 506 represents node 324 with interconnects 351, 352, and 354 of FIG. 3. Segment 508 represents node 325 with interconnects 352, 353, and 355 of FIG. 3. A “P” bit means that the interconnect is a primary link. A primary link is a link directly between two nodes in the same virtual domain.

An “S” bit means that the interconnect is a secondary link. A secondary link is a link wherein only one end of the interconnect is connected directly to a node in the virtual domain. For example, in FIG. 3, interconnect 351 is a secondary link for node 323 because one end of interconnect 351, the end connected to node 323 is a part of virtual domain 326. Additionally, even though node 324 is not part of virtual domain 326, node 324 is connected to node 321, which is part of virtual domain 326 via interconnect 354. Therefore, packets from processors in node 323 may travel to node 321 via the route of interconnect 351 to node 324 and then through interconnect 354 to node 321. A “0” bit, or null link, means that the interconnect is not connected to a node in the virtual domain. Thus, the link is neither a primary link nor a secondary link to the virtual domain.

In segment 502, the bits are P, S, and S, indicating that interconnect 350 is a primary link between two nodes in virtual domain 326, and interconnects 353 and 354 are secondary links between two nodes in virtual domain 326. In segment 504 the bits are P, S, and S, indicating that interconnect 350 is a primary link between two nodes in virtual domain 326, and interconnects 351 and 355 are secondary links between two nodes in virtual domain 326. In segment 506 the bits are 0, S, and S, indicating that interconnect 352 is not a primary link or a secondary link and that interconnects 351 and 354 are secondary links between two nodes in virtual domain 326. In segment 508 the bits are 0, S, and S, indicating that interconnect 352 is not a primary link or a secondary link and that interconnects 353 and 355 are secondary links between two nodes in virtual domain 326.

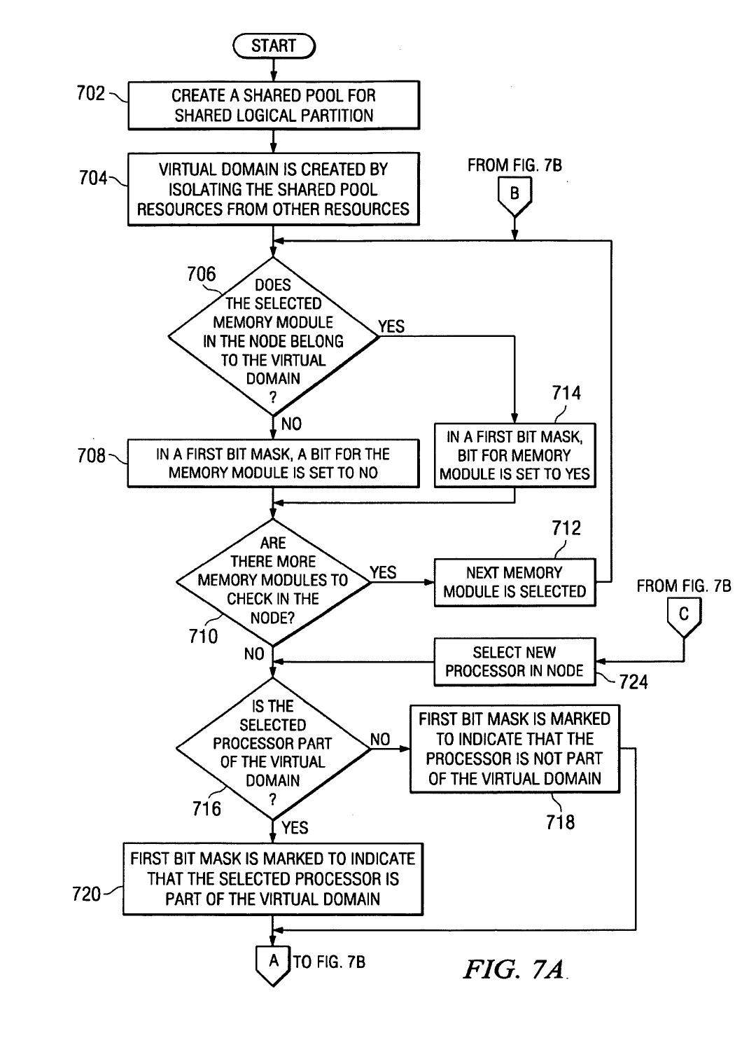

FIG. 6 is a flowchart illustrating the operation of managing cache coherence in a virtual machine managed system in accordance with an exemplary embodiment. The operation of FIG. 6 may be performed by a cache coherence engine, such as cache coherence engine 340 of FIG. 3. The operation begins when a processor issues a message to be broadcast (step 602). The message can be any type of cache coherence message such as a cache read/write miss, a snoop request, an address request, a data request, or any other type of message that a processor broadcasts. A determination is made as to whether the processor is part of a virtual domain (step 604).

If the processor is not part of a virtual domain (a “no” output to step 604), a local pump message is issued (step 606). If a negative acknowledgement (NACK) message is received regarding the address, then a system pump is issued (step 608) and the process ends.

If the processor is determined to be within the virtual domain (a yes output to step 604), then the message, along with a routing bit mask, is sent to the destination node from the source node (step 610). The message is a multicast message. The source node is the node to which the processor belongs and the destination node is another node in the virtual domain. The routing bit mask indicates whether an interconnect is a primary link, a secondary link, or neither a primary nor secondary link.

Responsive to receiving the message and routing bit mask at an interconnect, a link is selected, based on the routing mask, to send the message and the routing bit mask over, forming a selected link (step 612). Primary links are selected in favor of secondary links. Links are selected so that the message is only broadcast to nodes within the virtual domain. If a selected link is congested, then, provided that an alternative link is available, the alternative link is selected (step 614). An alternative link is a secondary link. The message and the routing bit mask are sent to the destination node over the selected link (step 616) and the operation ends.

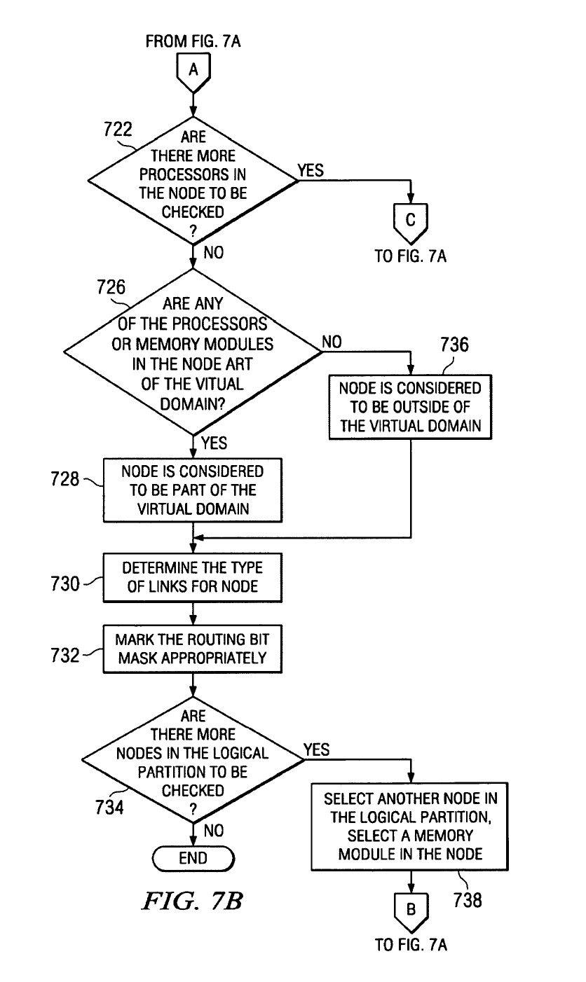

FIGS. 7A & 7B are a flowchart illustrating the operation creating a routing bit mask in accordance with an exemplary embodiment. The operation of FIGS. 7A & 7B may be performed by a cache coherence engine, such as cache coherence engine 340 of FIG. 3. The operation begins by creating a shared pool for shared logical partition (step 702). A virtual domain is created by isolating the shared pool resources from other resources (step 704). A determination is made as to whether a selected memory module, such as a dynamic random access memory (DRAM) module in the node belongs to the virtual domain (step 706). If a memory module does not belong to the virtual domain (a “no” output to step 706), then, in a first bit mask, a bit for the memory module is set to no (step 708). A determination is made as to whether there are more memory modules to check in the node (step 710). If there are not any more memory modules to check (a “no” output to step 710), the process proceeds to step 716. If there are more memory modules to check (a “yes” output to step 710), the next memory module is selected (step 712) and the process returns to step 706.

If the memory module does belong to the virtual domain (a “yes” output to step 706), then, in a first bit mask, the bit for the memory module is set to yes (step 714). A determination is made as to whether there are more memory modules to check in the node (step 710). If there are not any more memory modules to check (a “no” output to step 710), the process proceeds to step 716. If there are more memory modules to check (a “yes” output to step 710), the next memory module is selected (step 712) and the process returns to step 706.

A determination is made as to whether a selected processor is part of the virtual domain (step 716). If the selected processor is not part of the virtual domain (a “no” output to step 716), a first bit mask is marked to indicate that the selected processor is not part of the virtual domain (step 718) and the process proceeds to step 722.

If the selected processor is part of the virtual domain (a “yes” output to step 712), a first bit mask is marked to indicate that the selected processor is part of the virtual domain (step 720). A determination is made as to whether there are more processors in the node to be checked (step 722). If there are more processors to be checked (a “yes” output to step 722), another processor in the node is selected (step 724) and the process returns to step 716. If there are not any more processors in the node to be checked (a “no” output to step 722), a determination is made as to whether at least one of the processors or memory modules in the node is part of the virtual domain (step 726). This determination is made by checking the first bit mask.

If it is determined that at least one the processors or memory modules in the node is part of the virtual domain (a “yes” output to step 726), then the node is considered to be part of the virtual domain (step 728). Determine a type of link that each interconnect connected to the node is (step 730) and mark a routing bit mask appropriately (step 732). If it is determined that at least one the processors or memory modules in the node is not part of the virtual domain (a “no” output to step 726), then the node is considered to be outside of the virtual domain (step 736). Determine a type of link that each interconnect connected to the node is (step 730) and mark a routing bit mask appropriately (step 732).

A primary link is a link directly between two nodes in the same virtual domain. A secondary link is a link wherein only one end of the interconnect is connected directly to a node in the virtual domain. A null link, means that the interconnect is not connected to a node in the virtual domain.

A determination is made as to whether there are more nodes in the logical partition to be checked (step 734). If there are more nodes in the logical partition to be checked (a “yes” output to step 734), select another node in the logical partition, select a memory module in the node (step 738) and return to step 706. If there are not any more nodes in the logical partition to be checked (a “no” output to step 732), the process ends.

The operation of FIGS. 7A & 7B may be performed at anytime a change occurs to a virtual domain. The operation may be instigated automatically or manually by an operator, such as a systems administrator. In an alternate exemplary embodiment, the mapping of the virtual domain is updated automatically, anytime a change to the virtual domain occurs.

Exemplary embodiments provide for mapping the architecture of the virtual processors abstraction, by overlaying this abstracted architecture on top of the node domain systems or SMP systems and enabling the cache coherence engine to use the virtualized abstracted architecture to optimize cache coherence traffic. This abstracted mapping achieves greater performance as the abstracted mapping creates isolation between non-shared processors or resources matching to how the system is used rather than matching to how the system is built. This virtualization abstraction architecture is dynamic. As this abstraction architecture changes, the underlying cache coherence engine dynamically changes the boundaries of virtual domains for managing cache coherence. A communication mechanism is enabled between cache coherence engine and the virtual machine to transfer the dynamic changes of the virtualization abstraction architecture. These virtualization abstraction architecture changes can be made by changing the logical partition configurations.

The invention can take the form of an entirely hardware embodiment, an entirely software embodiment or an embodiment containing both hardware and software elements. In a preferred embodiment, the invention is implemented in both in hardware and software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method, for managing cache coherence in a virtual machine managed system, the computer implemented method comprising:
responsive to a processor issuing a message to be broadcast, determining whether the processor is part of a virtual domain;
responsive to a determination that the processor is part of the virtual domain, sending the message and a first bit mask from a source node to a destination node, wherein the source node is a node to which the processor belongs and the destination node is another node in the virtual domain and wherein the first bit mask indicates whether an interconnect is a primary link, a secondary link, or neither a primary nor a secondary link, wherein a primary link is an interconnect that directly connects a node in a virtual domain to another node in the virtual domain and wherein a secondary link is an interconnect that connects a node in the virtual domain to another node in the virtual domain through one or more nodes that are not part of the virtual domain;
responsive to receiving the message and the first bit mask; selecting, based on the first bit mask, one of a primary link or a secondary link over which to send the message and the first bit mask, forming a selected link; and
sending the message and the first bit mask to the destination node over the selected link.

2. The computer implemented method of claim 1, wherein determining whether the processor is part of the virtual domain comprises:
checking a second bit mask, wherein the second bit mask indicates whether each processor in a node is part of the virtual domain.

3. The computer implemented method of claim 1, further comprising:
responsive to the selected link being congested, selecting an alternative link, wherein the alternative link is a secondary link.

4. The computer implemented method of claim 1, wherein a primary link is selected in preference to a secondary link.

5. The computer implemented method of claim 1, further comprising:
marking, for each interconnect of a node, the first bit mask to indicate that an interconnect is one is one of a primary link, a secondary link, or neither a primary nor a secondary link.

6. The computer implemented method of claim 5, further comprising:
creating a shared pool of resources for a shared logical partition;
isolating the shared pool of resources from other resources, forming a virtual domain; and
responsive to a determination that a memory module belongs to the virtual domain, setting a bit in a second bit mask to indicate that the memory module belongs to the virtual domain.

7. The computer implemented method of claim 6, further comprising:
responsive to a determination that the processor belongs to the virtual domain, marking the second bit mask to indicate that the processor belongs to the virtual domain.

8. The computer implemented method of claim 7, wherein marking, for each interconnect of a node, the first bit mask to indicate that an interconnect is one of a primary link, a secondary link, or neither a primary nor a secondary link comprises:
checking the second bit mask to determine whether a node that each end of the interconnect is connected to belongs to the virtual domain, wherein the second bit mask indicates whether a node is part of the virtual domain; and
marking the first bit mask based on the second bit mask.

9. The computer implemented method of claim 8, wherein the node is determined to be part of the virtual domain responsive to the second bit mask indicating that at least one of the processors of the node belongs to the virtual domain.

10. The computer implemented method of claim 8, wherein the node is determined to be part of the virtual domain responsive to the second bit mask indicating that at least one of the memory modules of the node belongs to the virtual domain.

11. The computer implemented method of claim 8, wherein the node is determined to be part of the virtual domain responsive to the second bit mask indicating that at least one of the processors of the node or that at least one of the memory modules of the node belongs to the virtual domain.

12. The computer implemented method of claim 6, wherein the memory module is a dynamic random access memory module.

13. The computer implemented method of claim 1, wherein the message is one of a read miss message, a write miss message, a snoop request, and an address request.

14. A computer program product comprising:
a computer recordable medium having computer usable program code for managing cache coherence in a virtual machine managed system, the computer program product comprising:
computer usable program code, responsive to a processor issuing a message to be broadcast, for determining whether the processor is part of a virtual domain;
computer usable program code, responsive to a determination that the processor is part of the virtual domain, for sending the message and a first bit mask from a source node to a destination node, wherein the source node is a node to which the processor belongs and the destination node is another node in the virtual domain and wherein the first bit mask indicates whether an interconnect is a primary link, a secondary link, or neither a primary nor a secondary link, wherein a primary link is an interconnect that directly connects a node in a virtual domain to another node in the virtual domain and wherein a secondary link is an interconnect that connects a node in the virtual domain to another node in the virtual domain through one or more nodes that are not part of the virtual domain;
computer usable program code, responsive to receiving the message and the first bit mask; for selecting, based on the first bit mask, one of a primary link or a secondary link over which to send the message and the first bit mask, forming a selected link; and
computer usable program code for sending the message and the first bit mask to the destination node over the selected link.

15. The computer program product of claim 14, further comprising:
computer usable program code for marking, for each interconnect of a node, the first bit mask to indicate that an interconnect is one is one of a primary link, a secondary link, or neither a primary nor a secondary link.

16. The computer program product of claim 15, further comprising:
computer usable program code for creating a shared pool of resources for a shared logical partition;
computer usable program code for isolating the shared pool of resources from other resources, forming a virtual domain; and
computer usable program code, responsive to a determination that a memory module belongs to the virtual domain, for setting a bit in a second bit mask to indicate that the memory module belongs to the virtual domain.

17. The computer program product of claim 16, further comprising:
computer usable program code, responsive to a determination that the processor belongs to the virtual domain, for marking the second bit mask to indicate that the processor belongs to the virtual domain.

18. The computer program product of claim 17, wherein the computer usable program code for marking, for each interconnect of a node, the first bit mask to indicate that an interconnect is one of a primary link, a secondary link, or neither a primary nor a secondary link comprises:
computer usable program code for checking the second bit mask to determine whether a node that each end of the interconnect is connected to belongs to the virtual domain, wherein the second bit mask indicates whether a node is part of the virtual domain; and
computer usable program code for marking the first bit mask based on the second bit mask.

19. A data processing system for managing cache coherence in a virtual machine managed system, the data processing system comprising:
a bus;
a communications unit connected to the bus;
a storage device connected to the bus, wherein the storage device includes computer usable program code; and
a processor unit connected to the bus, wherein the processor unit executes the computer usable program code to, responsive to a processor issuing a message to be broadcast, determine whether the processor is part of a virtual domain; responsive to a determination that the processor is part of the virtual domain, send the message and a first bit mask from a source node to a destination node, wherein the source node is a node to which the processor belongs and the destination node is another node in the virtual domain and wherein the first bit mask indicates whether an interconnect is a primary link, a secondary link, or neither a primary nor a secondary link, wherein a primary link is an interconnect that directly connects a node in a virtual domain to another node in the virtual domain and wherein a secondary link is an interconnect that connects a node in the virtual domain to another node in the virtual domain through one or more nodes that are not part of the virtual domain; responsive to receiving the message and the first bit mask; select, based on the first bit mask, one of a primary link or a secondary link over which to send the message and the first bit mask, forming a selected link; and send the message and the first bit mask to the destination node over the selected link.

20. The data processing system of claim 19, wherein the processor further executes the computer useable program code to, for each interconnect of a node, the first bit mask to indicate that an interconnect is one is one of a primary link, a secondary link, or neither a primary nor a secondary link; create a shared pool of resources for a shared logical partition; isolate the shared pool of resources from other resources, forming a virtual domain; responsive to a determination that a memory module belongs to the virtual domain, set a bit in a second bit mask to indicate that the memory module belongs to the virtual domain; responsive to a determination that the processor belongs to the virtual domain, mark the second bit mask to indicate that the processor belongs to the virtual domain; and
wherein the processor executing the computer usable program code to mark, for each interconnect of a node, the first bit mask to indicate that an interconnect is one of a primary link, a secondary link, or neither a primary nor a secondary link comprises:
the processor further executing the computer usable program code to check the second bit mask to determine whether a node that each end of the interconnect is connected to belongs to the virtual domain, wherein the second bit mask indicates whether a node is part of the virtual domain; mark the first bit mask based on the second bit mask.
